(19) United States
(12) Patent Application Publication
(10) Pub. No.: US 2026/0339270 A1
(43) Pub. Date: Oct. 29, 2026

(54) WATCH WITH A TRANSPARENT OR TRANSLUCENT COLOURED DECORATION, PARTICULARLY IN ENAMEL

(71) Applicant: The Swatch Group Research and Development Ltd, Marin-Epagnier (CH)

(72) Inventors: Pierpasquale TORTORA, Neuchâtel (CH); Loïc Reymond, Neuchâtel (CH)

(73) Assignee: The Swatch Group Research and Development Ltd, Marin-Epagnier (CH)

(21) Appl. No.: 19/456,488

(22) Filed: Jan. 22, 2026

(30) Foreign Application Priority Data
Apr. 23, 2025 (EP) 25172010.8

(51) Int. Cl. G04B 45/00; G04B 39/00

(52) U.S. Cl. CPC G04B 45/0015; G04B 39/00

(57) ABSTRACT

A watch (2) including a case (4), a movement (6) incorporated in the case and extending globally in a general plane (8), a first glass (10) forming the back of the case, a second glass (12) located on the side of the front face (5) of the watch and at least partially facing the first glass, and a decorative structure (16). The decorative structure includes a transparent and/or translucent part located at least partially between the first and second glasses and which is visible through these first and second glasses in an axial direction that is perpendicular to said general plane. Between the transparent and/or translucent part and the first glass (10), an optical structure (22) is arranged to transmit most (26a) of a visible light (26) incident from the first glass, and to reflect most (28a) of a visible light (28) incident from the second glass.

### CROSS REFERENCE TO RELATED APPLICATIONS

This application claims priority to European Patent Application No. 25172010.8, filed on Apr. 23, 2025, the entire contents of which are incorporated herein by reference.

### Technical field of the invention

The present invention relates to a watch with a transparent and/or translucent decorative structure.

More specifically, the invention relates to a watch with a transparent or translucent enamel decoration, particularly plique-à-jour enamel, that is visible from the front face and from the back of the watch.

### Technological background

When transparent or translucent enamels are arranged in openings in a structure that is initially pierced, similar to stained glass but on a horological scale, this is referred to as plique-à-jour enamel, that is, a transparent or translucent enamel object created using the plique-à-jour technique. This technique is therefore similar to the stained glass technique, in that transparent or translucent enamels, generally coloured in various shades, are inserted into various openings formed by a cloisonné structure with no back, meaning that the cloisonné structure has through openings. After firing the enamels cast into the openings, the result is an object with a cloisonné structure, usually metallic, in which the various openings are filled with transparent or translucent enamels through which light can at least partially pass.

Watches with colourful plique-à-jour enamel decoration are common, particularly watches with an upper glass, a lower glass, and a movement that is smaller in size than these two glasses. A flat decorative structure in plique-à-jour enamel is arranged around the periphery of the movement; this structure being arranged on the upper glass side such that it is at least partially axially visible through the upper glass and the lower glass. Thus, by looking through the two glass panes and the decorative structure when holding the watch so that the ambient light falls on the rear face of the decorative structure relative to the glass through which the observer is looking at this decorative structure, the various enamels can be observed transparently as they are backlit by the ambient light. The plique-à-jour effect is maximised when the part is observed when backlit. In the absence of backlighting, whether natural or artificial, and when lit only by ambient light, the transparent and translucent parts of the piece darken and the colours of the enamel appear less vivid. Thus, when the user wears the watch on their wrist, no ambient light penetrates through the lower glass (the glass fitted into the back of the case). In this case, the decorative plique-à-jour enamel structure is not backlit, which means that its transparency and the brilliance of the coloured enamels cannot be fully appreciated. The colourful decoration then appears dull, making the watch less attractive when worn.

To remedy the aforementioned problem, patent document EP 4421568, which relates to a watch as described above, proposes to arrange an electroluminescent source under the horology movement and at least one mirror on the lower glass facing this light source. This design does add a certain brilliance to the enamel decoration when the user is wearing the watch, but this solution has at least three drawbacks. Firstly, the desired brilliance when worn is only achieved when the electroluminescent source is activated, either by an external control device or by an internal mechanism in the watch at certain times or in response to other events. Then, this solution requires incorporating electrical components and a power source into the watch, which is not always desirable in high-end watches, which are often preferred to be entirely mechanical, meaning with no electrical parts and/or electronic circuits. Thirdly, this solution makes the watch thicker, as a certain amount of space is required between the horology movement and the lower glass in the embodiment shown in the figures and described in detail. To sum up, it should be understood that incorporating a decorative structure with transparent or translucent enamels forming a sort of small stained-glass panel into a watch presents a real problem in terms of the watch's attractiveness, particularly for conventional mechanical watches.

### Summary of the invention

The present invention aims to provide a solution to the aforementioned drawbacks by providing a watch with a decorative structure that is at least partially transparent and/or translucent, in particular coloured, and optical means for imparting brilliance to such a decorative structure when the user is wearing the watch on their wrist, while preserving the plique-à-jour effect.

To this end, the invention relates to a watch comprising a case, a movement incorporated in the case and extending globally in a general plane, a first glass forming the back of the case, a second glass located on the side of the front face of the watch and at least partially facing the first glass, and a decorative structure that comprises at least one transparent and/or translucent part located at least partially between the first and second glasses and which is visible through these first and second glasses in an axial direction that is perpendicular to said general plane. The watch comprises, between said at least one transparent and/or translucent part of the decorative structure and the first glass, an optical structure arranged so as to transmit most of a visible light incident from the first glass, in particular in the axial direction, and to reflect most of a visible light incident from the second glass, in particular in the axial direction.

In one main embodiment, the optical structure is formed by an optical layer, an optical plastic film or an optical plate.

In a general embodiment, the optical structure forms a reflector or a reflective diffuser, located behind said at least one transparent and/or translucent part of the decorative structure, for the visible light incident from the second glass and a transmissive diffuser for the visible light incident from the first glass.

In a preferred embodiment, the optical structure has, on the side of the first glass forming the back of the case, a structured surface defining an array of raised and/or hollow triangular pyramids, each triangular pyramid being defined by three facets on the structured surface with any one of the three facets being orthogonal to the other two facets.

In a preferred alternative embodiment, the triangular pyramids are configured and spatially arranged so that the array of triangular pyramids entirely covers, in axial superposition, said at least one transparent and/or translucent part of the decorative structure.

In an advantageous alternative embodiment, the triangular pyramids are raised and have a height of less than five hundred micrometres.

### BRIEF DESCRIPTION OF THE FIGURES

The invention will be described in greater detail below with reference to the appended drawings, which are given by way of non-limiting examples, in which:

FIG. 1 is a top view of a first embodiment of a watch according to the invention;

FIG. 2 is a cross-sectional view along line II-II of the watch in FIG. 1;

FIG. 3A is a partial view, in plan and in cross-section, of a first alternative embodiment of an optical structure arranged under the decorative structure of the watch in FIG. 1;

FIGS. 3B and 3C show a partial top view and a cross-sectional view, respectively, of a second alternative embodiment and of a third alternative embodiment of an optical structure arranged under the decorative structure of the watch in FIG. 1;

FIG. 4 is a partial cross-sectional view, similar to that of FIG. 2, of an alternative embodiment of an assembly formed by the decorative structure and an optical plastic film according to the invention;

FIG. 5 is an enlarged partial view of FIG. 4; and

FIG. 6 is a partial cross-sectional view, similar to that of FIG. 4, of a second embodiment of a watch according to the invention.

### DETAILED DESCRIPTION OF THE INVENTION

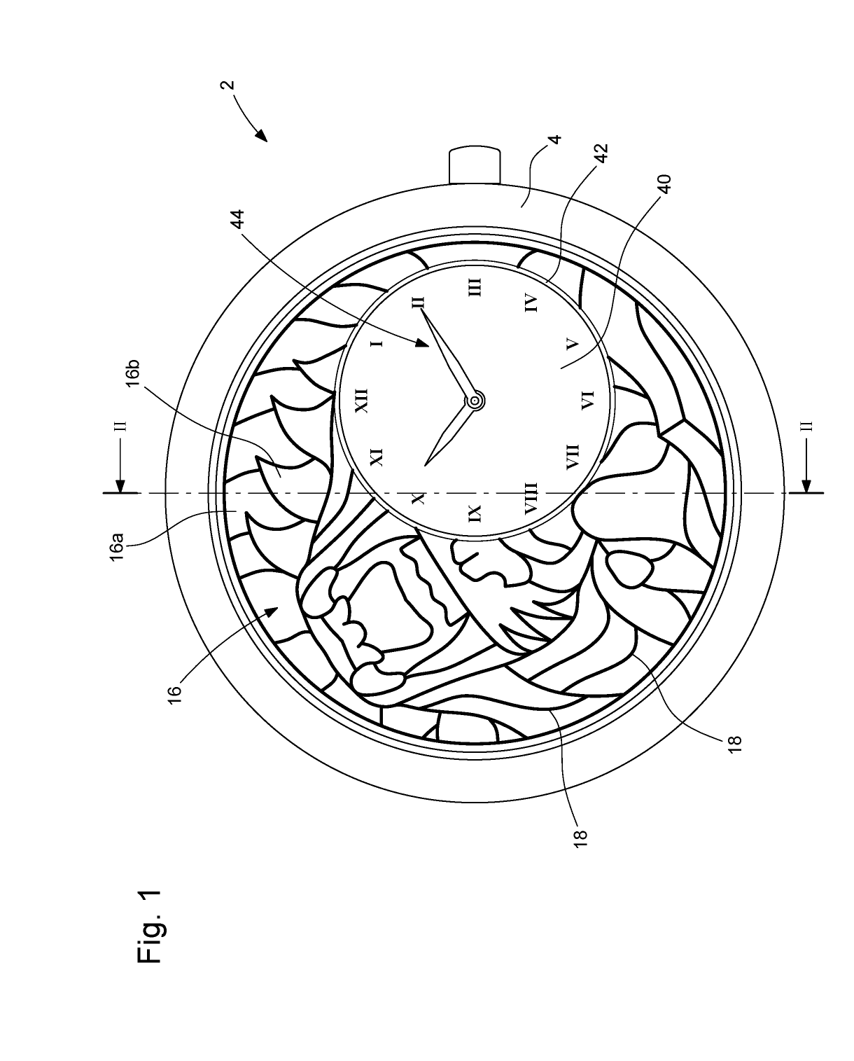

Referring to FIGS. 1-5, a first embodiment of a watch according to the invention will be described below, with various alternative embodiments.

The watch 2 comprises a case 4, a movement 6 incorporated in the case and extending globally in a general plane 8, a first glass 10 forming the back of the case, a second glass 12 located on the side of the front face 5 of the watch and at least partially facing the first glass, and a decorative structure 16. The movement 4 is associated with an analogue display 44 located above a dial 40 covering the movement, which is fitted and fastened in a fitting circle 42 that is inserted into an opening in the decorative structure. The decorative structure is thus arranged at the periphery of the movement. Generally speaking, the decorative structure comprises at least one transparent and/or translucent part located between the first and second glasses 10 and 12 and visible through these first and second glasses in an axial direction 14 that is perpendicular to the general plane 8. In the alternative embodiments shown, the decorative structure 16 comprises several transparent and/or translucent parts 16a, 16b, each formed from a coloured enamel and separated by partitions 18, in particular made of metal. The decorative structure 16 thus forms a plique-à-jour enamel decoration, in other words, a stained-glass panel with horological dimensions. In another embodiment, the decorative structure can at least partially cover the movement 6 and comprise transparent and/or translucent coloured parts forming a plique-à-jour decoration through openings provided in this movement, for example in a sprung balance. The decorative structure 16 comprises an outer annular part 19, in particular made of metal, that surrounds all of the transparent and/or translucent parts and is used to fit and fasten the decorative structure 16 in the case 4.

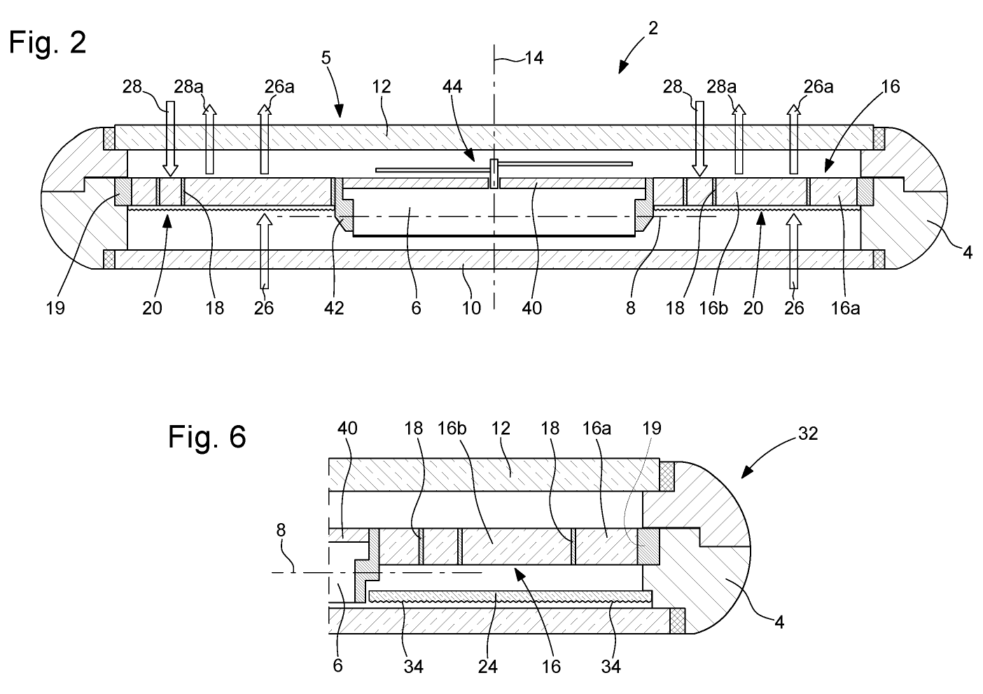

Generally speaking, the watch according to the invention comprises, between said at least one transparent and/or translucent part of the decorative structure 16 and the first glass 10, an optical structure that is arranged so as to transmit most 26a of a visible light 26 incident from the first glass 10, in particular in the axial direction 14, and to reflect most 28a of a visible light 28 incident from the second glass 12, in particular in said axial direction. In a general alternative embodiment, the optical structure forms a reflector or a reflective diffuser, located behind said at least one transparent and/or translucent part 16a, 16b of the decorative structure 16, for the visible light 28 incident from the second glass 12 and a transmissive diffuser for the visible light 26 incident from the first glass 10. In the alternative embodiment shown in FIGS. 1 and 2, the optical structure is formed by an optical layer 20 that is deposited directly onto the lower/rear surface of the decorative structure 16 at least under said at least one transparent and/or translucent part. The optical layer 20 has a structured surface on the side of the glass 10 (side of the back of the case), preferably in contact with the air present in the case 4.

Preferably, the optical structure has, on the side of the first glass 10 (the glass located in the back of the watch), a structured surface defining an array of raised triangular pyramids 34 and/or hollow triangular pyramids 35, each raised triangular pyramid being defined by three facets 34a, 34b, 34c of the structured surface and each hollow triangular pyramid being defined by three facets 35a, 35b, 35c of this structured surface. The raised triangular pyramids 34 and/or the hollow triangular pyramids 35 are configured so that any one of the three facets 34a, 34b, 34c, respectively 35a, 35b, 35c of a triangular pyramid is orthogonal to the other two facets. The expression “hollow triangular pyramid” is taken to mean a recess in a substrate forming the optical structure, the shape of the void in this recess being a triangular pyramid defined by three facets 35a, 35b, 35c of the structured surface of the optical structure. The said three facets of the triangular pyramids define separation surfaces between the medium of the optical structure and the outer medium, which has a refractive index that is smaller than the refractive index of the medium of the optical structure. Preferably the outer medium is air. This particular characteristic confers an interesting optical property, namely that a light beam that is incident on one of said three facets from the medium of the optical structure and is reflected by the optical structure is then reflected parallel to the incident light beam.

The raised triangular pyramids 34, in other words, the triangular-based pyramidal mini optical prisms, are advantageously made of the same material as the substrate of the optical structure. The substrate medium is chosen such that a light beam incident on the decorative structure 16 in the axial direction 14 is reflected by the optical structure in the axial direction (it should be noted that the decorative structure and the optical structure extend in general planes that are parallel to the general plane 8 of the movement 6). On the other hand, a light beam incident in the axial direction 14 on one of said three facets of a triangular pyramid from the medium outside the optical structure, on the side of the triangular pyramids whose said three facets define the structured surface of the optical layer 20, is transmitted through the optical structure with an angular deflection. The refractive index of the medium forming the substrate and, where applicable, the raised triangular pyramids, defines the maximum angle, from the axial direction 14, for a light beam to be completely reflected in the optical structure when it is incident from the second glass 12 (the one located on the side of the front face 5 of the watch) on this optical structure (and therefore on one of the three facets of one of the triangular pyramids from the medium of the substrate) and thus to be reflected by the optical structure, which produces the desired effect.

The optical layer 20 can be produced in various ways. In a first manufacturing method, a resin is deposited on the lower surface of the decorative structure. The resulting resin layer is at least partially cured and the structured surface is then produced using a die (a tool used to distort or compress a material object) that is pressed onto the at least partially cured resin layer. In a second manufacturing method, the optical layer can be produced by rolling a transparent plastic film directly onto the said lower surface, this transparent plastic film having or not yet having a structured surface. Here again, if the plastic film does not have a structured surface before being rolled, the structured surface is then obtained using a die pressed against the plastic film once it has been rolled on the lower surface of the decorative structure. In a particular alternative embodiment, the structured surface is obtained during rolling.

A special embodiment of the optical structure, which is not shown in the figures, consists in machining the lower part of the decorative structure, at least in the region or, where appropriate, the regions, of said at least one transparent and/or translucent part, to obtain in this region or these regions a raised structured lower surface according to the invention, for example the array of triangular pyramids generally defined above and which is described in detail in the following alternative embodiments. In an alternative embodiment, said at least one transparent and/or translucent part is obtained by casting in at least one mould, the lower surface of which is structured so as to form said structured surface on the underside of said at least one transparent and/or translucent part. It should be noted that the mould can advantageously be made up of partitions 18 of the decorative structure and of a work plate closing the lower part of the openings defined by these partitions 18 and structured so as to form said structured surface when the transparent or translucent parts 16a, 16b are cast in these openings when manufacturing the decorative structure. The work plate is then removed. This special embodiment therefore combines the decorative structure and the optical structure, which are no longer materially distinct or separate, but are combined in a single decorative object. It should be noted that this special embodiment is not preferred, but is also covered by the invention. In this case, the decorative structure is considered to be formed by an upper part of the decorative object, while the lower part of this decorative object defines the optical structure according to the invention, this lower part optionally comprising only the triangular pyramids in the case of an array of raised triangular pyramids.

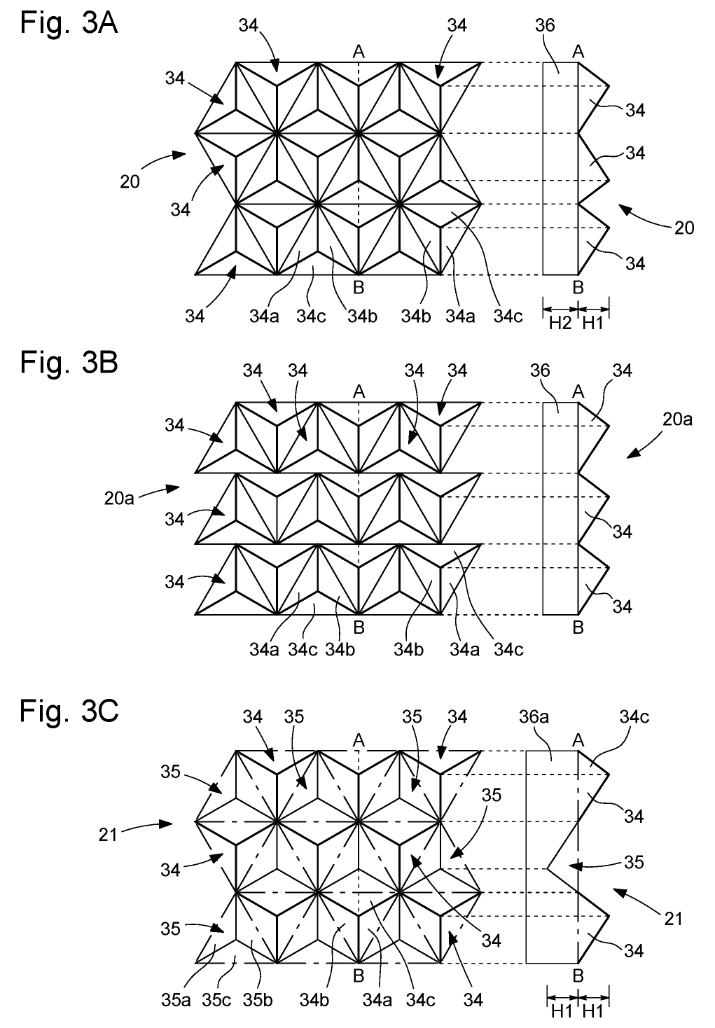

FIGS. 3A-3C show, in an underside view (meaning from the side of the glass 10 forming the back of the case), three alternative embodiments of an optical structure according to the invention (which can be selected for each embodiment of the first embodiment and also for the other embodiments of the invention described or which may be considered by a person skilled in the art). Each of these three alternative embodiments is advantageous, firstly in that the lower structured surface defines an array of raised and/or hollow triangular pyramids that all contribute to the desired optical effect, namely to transmit most 26a of the visible light 26 incident from the first glass 10, in particular in the axial direction 14, and to reflect most 28a of a visible light 28 incident from the second glass 12, in particular in said axial direction, and by the fact that the raised and/or hollow triangular pyramids are spatially configured and arranged so that the array of triangular pyramids entirely covers, in axial superposition, said at least one transparent and/or translucent part 16a, 16b of the decorative structure 16.

FIG. 3A shows a first preferred alternative embodiment of the optical structure. In this first alternative embodiment, the lower structured surface of the optical structure 20 is formed by an array of raised triangular pyramids 34. The term “lower” is taken to mean the surface of the optical structure located on the side of the glass 10 forming the back of the case. Each row in this array is arranged with the triangular bases of the pyramids lying in a plane parallel to the general plane of the optical structure 20, and thus to the general plane 8, these triangular bases being oriented alternately in one direction and in the reverse direction in a direction perpendicular to the direction defined by the row. Next, two adjacent rows in the array are axially symmetrical relative to the geometric line separating the two adjacent rows. In other words, the alternating pyramids in one row have a phase shift of half a period with the two adjacent rows or with the adjacent row for the first row or the last row in the array. The first alternative embodiment of an optical structure offers an advantage for producing this optical structure when the lower structured surface is obtained by direct machining an initially flat plate, in particular made of glass or crystal. In fact, in this case, the array of triangular pyramids can be machined in the plate using a chisel that moves in three directions, angularly offset by 120° relative to the other two, in a coordinate frame fastened to the plate. This chisel is designed to create linear grooves with a V-shaped transverse profile, in other words, with two non-parallel straight lines that intersect at the back of the groove and that each have an inclination corresponding to the inclination, in absolute value, provided for the three facets of each pyramid relative to the axial direction.

In another alternative embodiment of the optical structure not shown in the figures, the structured surface has an arrangement of triangular pyramids similar to the one in FIG. 3A, but with all of the triangular pyramids being hollow. This alternative embodiment can be advantageous when the structured surface of the optical structure is obtained by moulding or by compressing material using a die that is pressed onto an initial layer of resin or an initial plastic film to produce an optical layer or an optical plastic film according to the invention by hot or cold distortion of this initial layer of resin or this initial plastic film to obtain the desired structured surface. The advantage of this alternative embodiment is that the design of the array can be less complex, since the triangular pyramids in the array are raised so as to obtain the hollow pyramids in the optical structure.

In an advantageous alternative embodiment, the raised triangular pyramids 34 have a height H1 of less than five hundred micrometres (500 µm).

In a preferred alternative embodiment, the raised triangular pyramids 34 have a height H1 of less than two hundred micrometres (200 µm).

The array of raised triangular pyramids 34 rises from a substrate 36. Preferably, the raised triangular pyramids and the substrate are made of the same material. However, in another alternative embodiment, the raised pyramids can be made of a material other than the substrate. This alternative embodiment can be achieved by forming the pyramids by depositing a transparent ink on the substrate with a pad. In the first alternative embodiment, the height/thickness H2 of the substrate 36 can be small, for example between 100 and 200 micrometres (100 to 200 µm). However, a greater height H2 can be foreseen as this has little influence on the optical properties of the optical structure. If the triangular pyramids are hollow, the height/thickness H2 of the substrate is greater than the height H1 of the pyramids, and is advantageously chosen to be between two and four times this height H1.

It has been observed that the substrate 36 can form a light guide for part of the light that has penetrated the optical structure, which has the effect of partially delocalising the reflection of the light by the optical structure. It should be noted that, in general, the transparent and/or translucent, in particular coloured, parts of the decorative structure cause the light passing through these transparent and/or translucent parts to scatter to some extent.

FIG. 3B shows a second alternative embodiment of the optical structure according to the invention, more particularly the structured surface of this optical structure 20a. In this second alternative embodiment, the triangular pyramids 34 are also raised and have the same configuration in each row in the array as in FIG. 3A. The difference is that there is no phase shift between two adjacent rows in the array. Columns of triangular pyramids can thus be differentiated from the triangular pyramids of two adjacent columns that have opposite orientations (in the direction defined by the columns in the array).

FIG. 3C shows a third alternative embodiment of the optical structure, more specifically the structured surface of this optical structure. The optical structure 21 is composed of raised triangular pyramids 34 and hollow triangular pyramids 35 forming recesses in the substrate 36a relative to a median plane between the raised triangular pyramids and the hollow triangular pyramids, this median plane being shown in dashed lines in FIG. 3C. Each row in the array of triangular pyramids alternately comprises raised triangular pyramids 34 and hollow triangular pyramids 35, with the hollow triangular pyramids 35 having a reverse orientation, relative to a direction orthogonal to the rows, to that of the raised triangular pyramids 34. Moreover, each raised triangular pyramid 34 in a given row is aligned, in said orthogonal direction, with a hollow pyramid 35 in each adjacent row in the array of triangular pyramids. This specific arrangement of the array of triangular pyramids has the effect that each of the three facets 34a, 34b and 34c of any raised triangular pyramid is extended by a facet 35a, respectively 35b and 35c of three respective hollow triangular pyramids with the same inclination relative to the axial direction (it should be noted that, obviously, the pyramids located at the rim of the structured surface can be truncated and that they do not all have their facets extended in this way). Thus, each flat surface of the structured surface is formed by a pair of facets 34a and 35a, respectively 34b and 35b, 34c and 35c.

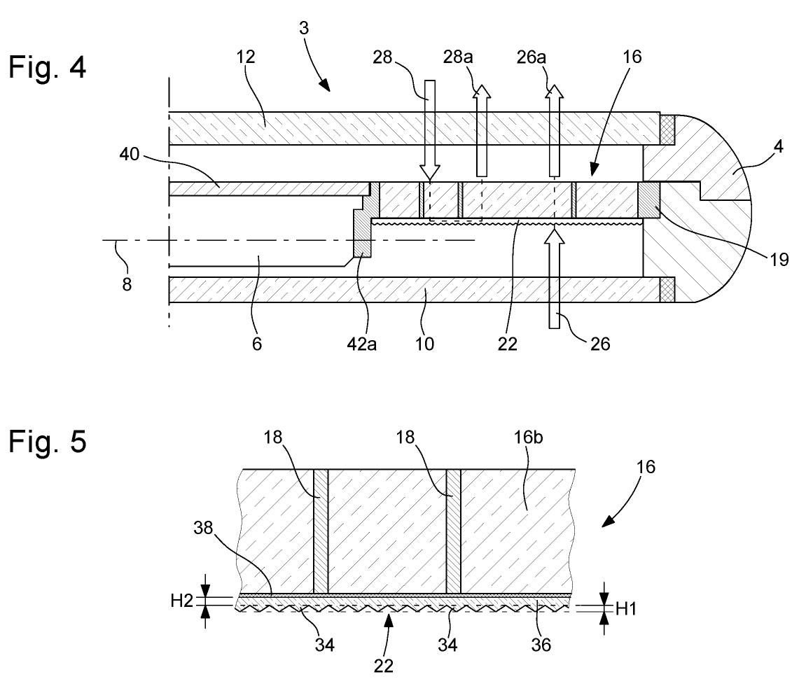

FIG. 4 shows a cross-section of an alternative to the first embodiment. References already described will not be described again in detail. FIG. 5 is a partial enlargement of FIG. 4. The watch 3 in this alternative embodiment can be distinguished from the previous alternative embodiment essentially by an optical structure formed by an optical plastic film 22 glued to a rear surface of the decorative structure 16. The optical plastic film 22 comprises an upper part that forms a continuous substrate 36 forming a light guide, from which the array of triangular pyramids 34 falls away to form the structured surface of this optical plastic film, particularly according to one of the alternative embodiments described in FIGS. 3A-3C. The optical plastic film 22 is therefore deposited on the lower/rear surface of the decorative structure 16 with a layer of glue 38, which can be deposited beforehand either on the said lower surface or on the flat upper surface of the plastic film. It should be noted that, according to a particular characteristic, the inner rim of the optical plastic film covers a small horizontal recess in the fitting circle 42a, in which the movement 6 is inserted, and the outer rim of this optical plastic film partially covers the outer annular part 19 of the decorative structure 16. This ensures a uniform optical effect for all of the transparent and/or translucent parts in the decorative structure.

The manufacturing method used to produce the optical plastic film can be similar to the ones already described for the optical layer 20. In a first advantageous alternative embodiment, the structured surface of the optical plastic film is produced in a press or rolling mill before it is glued to the lower surface of the decorative structure. This structured surface can be obtained by hot or cold distortion or compression in a press comprising a die for this purpose or in a rolling mill in which one roll, particularly a last roll in a final step, has a relief defining the negative of the intended structured surface. In a second alternative embodiment, the structured surface is produced in a press after the optical plastic film has been glued to the decorative structure.

In a second embodiment, the optical structure is formed by an optical plate 24 fitted in the case 4 without being fastened to the decorative structure 16. It should be noted that references already described in detail above will not be described again here. In the alternative embodiment shown in FIG. 6, the watch 32 comprises an optical plate 24 that is spaced apart from the decorative structure 16. In another alternative embodiment, the optical plate can be in contact with the lower surface of the decorative structure. Advantageously, this optical plate 24 is made of glass or crystal, but in an alternative embodiment it can be made of a synthetic material (in particular hard plastic). In the case of a quartz plate, but also advantageously in the case of a glass plate, the structured surface is preferably obtained by machining using a tool equipped with a material ablation tool, for example with an industrial diamond cutter. The array of triangular pyramids 34 is thus advantageously configured according to the arrangement in FIG. 3A. In the alternative embodiment shown, the optical plate 24 is fitted from the back of the watch 32, before the lower glass is fitted in the back. In one alternative embodiment, the case can have a separate back that can be detached from the middle, enabling the optical plate to be fitted to the middle, as shown in FIG. 6, before closing the watch case 4 by assembling the back with the middle.

1. A watch comprising:
a case, a movement incorporated in the case and extending generally in a general plane;
a first glass forming the back of the case;
a second glass located on the side of a front face of the watch and at least partially facing the first glass; and
a decorative structure, that comprises at least one transparent and/or translucent part located at least partially between the first and second glasses and visible through the first and second glasses in an axial direction that is perpendicular to said general plane,
wherein the watch comprises, between said at least one transparent and/or translucent part of the decorative structure and the first glass, an optical structure arranged so as to transmit most of a visible light incident from the first glass, in the axial direction, and to reflect most of a visible light incident from the second glass, in the axial direction.

2. The watch according to claim 1, wherein the optical structure is formed by an optical layer, an optical plastic film or an optical plate.

3. The watch according to claim 1, wherein the optical structure forms a reflector or areflective diffuser, located behind said at least one transparent and/or translucent part of the decorative structure, for the visible light incident from the second glass and a transmissive diffuser for the visible light incident from the first glass.

4. The watch according to claim 1, wherein the optical structure has, on the side of the first glass forming the back of the case, a structured surface defining an array of raised and/or hollow triangular pyramids, each triangular pyramid being defined by three facets on the structured surface with any one of the three facets being orthogonal to the other two facets.

5. The watch according to claim 4, wherein the triangular pyramids are configured and spatially arranged so that the array of triangular pyramids entirely covers, in axial superposition, said at least one transparent and/or translucent part of the decorative structure.

6. The watch according to claim 4, wherein the triangular pyramids have, in the axial direction, a height (H1) that is less than five hundred micrometres.

7. The watch according to claim 4, wherein the triangular pyramids have, in the axial direction, a height (H1) of less than two hundred micrometres.

8. The watch according to claim 1, wherein the optical layer is deposited directly on a rear surface of the decorative structure.

9. The watch according to claim 1, wherein the optical plastic film is glued to a rear surface of the decorative structure.

10. The watch according to claim 1, wherein the optical plate is fitted in the case without being fastened to the decorative structure.

11. The watch according to claim 1, wherein the decorative structure comprises a plurality of transparent and/or translucent parts each formed of a coloured enamel and separated by partitions, such that the decorative structure forms a stained-glass panel with horological dimensions.
